(19) United States
(12) Patent Application Publication
(10) Pub. No.: US 2023/0291000 A1
(43) Pub. Date: Sep. 14, 2023

(54) Graphene Solid State Battery

(71) Applicant: Shaune Pierre Bordere, Cypress, TX (US)

(72) Inventor: Shaune Pierre Bordere, Cypress, TX (US)

(21) Appl. No.: 17/693,465

(22) Filed: Mar. 14, 2022

(51) Int. Cl. H01M 10/0562; H01M 50/431; H01M 4/131; H01M 4/38; H01M 4/62; H01M 50/449; H01M 50/117; H01M 50/128; H01M 4/04

(52) U.S. Cl. CPC H01M 10/0562; H01M 4/0428; H01M 4/131; H01M 4/38; H01M 4/625; H01M 50/117; H01M 50/128; H01M 50/431; H01M 50/449; H01M 2004/027

(57) ABSTRACT

According to one embodiment, a secondary battery including, a solid state negative anode, a solid state positive cathode, a solid state electrolyte, a solid neutralized separator and a solid graphene casing is provided. The negative anode includes solid 100 femtosecond laser induced confined microexplosion energy density enhanced charged Graphene Oxide Nickel-Copper. The positive cathode includes solid 100 femtosecond laser induced confined microexplosion energy density enhanced positively charged Graphene Nickel-Copper. The electrolyte includes solid 100 femtosecond laser induced confined microexplosion energy density enhanced Fluorinated Graphene (GF_{0.8}). The solid separator includes solid state Carboxyl neutralized Graphene quantum dots positioned between the anode and the cathode. The casing includes 100 layers of solid Graphene.

### CROSS-REFERENCE TO RELATED APPLICATIONS

This application claims the benefit of US Provisional Application No. 63/182,215, filed on Apr. 30, 2021; the entire disclosures of which are incorporated herein by reference.

### BACKGROUND

Current energy storage systems generally rely on chemical-based designs. For example, a popular battery type is the Lithium-ion (Li-ion) style battery. Li-ion batteries house Lithium which can be dangerous because Lithium-ion batteries are known to be explosive and flammable because Lithium’s melting point (108.5° C.) and boiling point (1,342° C.) is so low. Their charging speed and storage capacity are also not keeping up with current battery driven demands as a result of their low energy density.

A limited amount of prior art discloses various methods of producing solid state batteries. U.S. Pat. No. US8790814B2 filed in 2012 and assigned to Global Graphene Group Inc. and Nanotek Instruments Group, LLC discloses “inorganic nano sheet-enabled Lithium-exchanging surface-mediated cells.” It describes an inorganic material based surface-mediated cell (SMC) comprising (a) a cathode comprising a non-Carbon-based inorganic cathode active material having a surface area to capture and store Lithium thereon; (b) an anode comprising an anode current collector alone or both an anode current collector and an anode active material; (c) a porous separator; (d) a Lithium-containing electrolyte in physical contact with the two electrodes, wherein the cathode has a specific surface area no less than 100 m²/g which is in direct physical contact with said electrolyte to receive Lithium ions therefrom or to provide Lithium ions thereto; and (e) a Lithium source. This inorganic SMC provides both high energy density and high-power density not achievable by supercapacitors and Lithium-ion cells.

However, the above prior art does not teach the same invention being described in the present invention.

Embodiments of the subject technology better address such issues as the ones described above.

### BRIEF SUMMARY OF THE INVENTION

In one aspect of the subject technology, a solid state Graphene battery is disclosed. The battery includes: a 100 single layered solid Graphene casing; a solid 100 femtosecond laser induced confined microexplosion energy density enhanced negatively charged Graphene Oxide Nickel-Copper nanocomposite anode positioned on one end of the casing; a 100 femtosecond laser induced confined microexplosion energy density enhanced positively charged Graphene Nickel-Copper nanocomposite cathode positioned on an opposite end of the casing; a 100 femtosecond laser induced confined microexplosion energy density enhanced Fluorinated Graphene (GF_{0.8}) electrolyte at its core; and a solid Carboxyl neutralized Graphene quantum dot separator positioned at the center of the electrolyte between the anode and the cathode.

### BRIEF DESCRIPTION OF THE SEVERAL VIEWS OF THE DRAWING

FIG. 1 is a diagrammatic representation of a solid state Graphene battery according to an embodiment of the subject disclosure.

FIG. 2 is a schematic representation of a process of preparing a Graphene battery according to an embodiment of the present invention.

### DETAILED DESCRIPTION OF THE INVENTION

The detailed description of some embodiments of the invention is made below with reference to the accompanying figures, wherein like numerals represent corresponding parts of the figures.

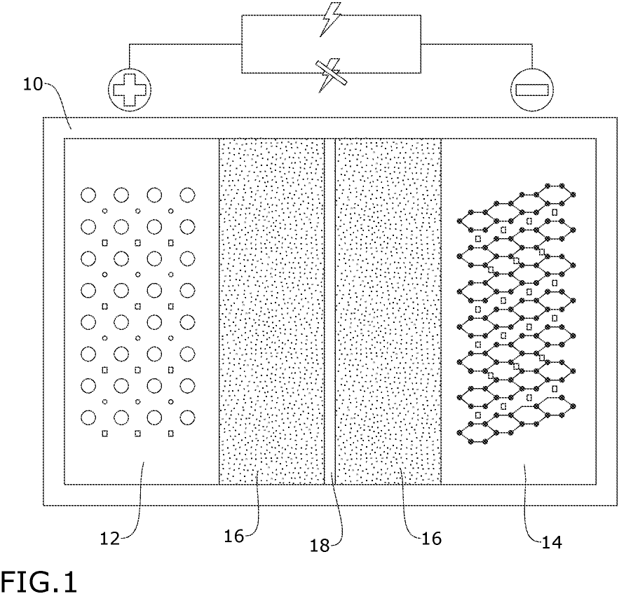

FIG. 1 is a diagrammatic representation of a graphene battery according to an embodiment of the subject disclosure.

In general and referring to the FIG. 1, embodiments of the present disclosure provide a solid state Graphene battery (sometimes referred to simply as “the battery”). The battery may be recyclable, rechargeable, renewable and sustainable. The battery may comprise a solid state Graphene structure. As will be appreciated, the battery is unique and the first of its kind in the world. The subject battery capitalizes on the use of Graphene from the Carbon Dioxide containing air. The battery comprises a solid layered Graphene casing 10, anode 12, cathode 14, electrolytes 16 and separator 18. Graphene is a Carbon allotrope that consists of a single layer of two-dimensional atoms in a hexagonal lattice. Each Carbon atom in Graphene forms a four-bond vertex. Graphene is the structural element of other Carbon allotropes. Nano scaled Graphene plates were first patented in 2002 by Bor Z. Jang and Wen C. Huang, yet Nobel Prize winning Physicists Andre Geim and Konstantin Novoselov at the University of Manchester extracted, isolated and characterized single atomthick crystallites from bulk Graphite in 2004.

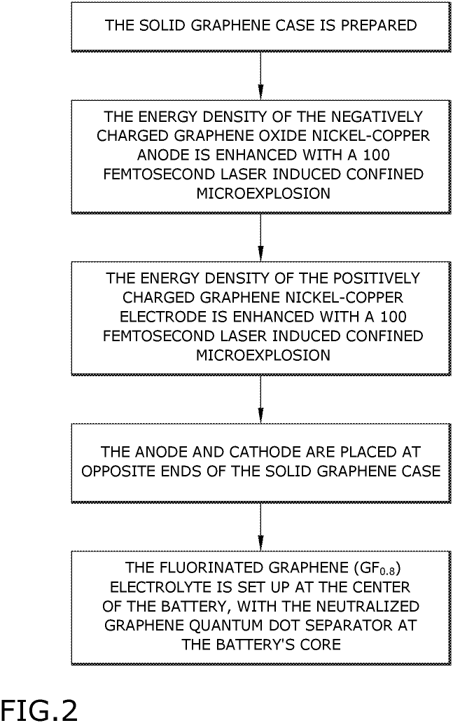

In an exemplary embodiment, the Graphene for the battery may be produced by a process of capturing Carbon Dioxide in the air utilizing Copper Palladium alloys and Atmospheric Pressure Chemical Vapor Deposition (APCVD) in accordance with FIG. 2. This synthesized Graphene may be used to produce the battery at various steps as taught under steps 201, 202, 203 and 204. As will also be appreciated, the Graphene battery is significantly more powerful and durable than Lithium-ion batteries.

In exemplary applications, the battery may be used to power an all-new lineup of Hydrogeninternal combustion cars, trucks, SUVs and passenger buses and all electric powered cars, trucks,SUV’s, airplanes, trains and passenger buses, which may be other embodiments of the subject technology disclosed herein. The high-powered battery of the subject disclosure may also be used to store solar energy in residential homes as well as commercial buildings, generators and power plants.

In an exemplary embodiment, the solid state battery may comprise a 100 femtosecond laser induced confined microexplosion energy density enhanced negatively charged Graphene Oxide Nickel-Copper nanocomposite anode, a 100 femtosecond laser induced confined microexplosion energy density enhanced positively charged Graphene Nickel-Copper nanocomposite cathode, a 100 femtosecond laser induced confined microexplosion energy density enhanced Fluorinated Graphene (GF_{0.8}) electrolyte, a Carboxyl neutralized Graphene quantum dot separator and a solid 100 single layered Graphene casing. See for example, the Figure for an exemplary arrangement.

The battery is exceptional and high performing compared to all other types of batteries currently available including Lithium-ion and Lithium metal batteries that are volatile and limited in the energy densities. The solid state battery of the subject disclosure does not contain explosive liquid material and has significantly more energy than all commonly available Lithium-ion batteries or Lithium metal batteries. The battery is ideal for electric vehicles and many more devices large and small, because they are safer, more durable, have a higher energy density and greater chargeability speed. There is currently no commercially available solid state battery with high energy density greater than Lithium-ion batteries that is safe, durable and rechargeable for vehicles, power plants, generators or even small devices. The current commercially available batteries have a limited number of charging cycles, major issues with dendrite and cavity formation that limits their effectiveness. They are increasingly more costly due to limited numbers of Lithium mines and they’re not sustainable. The Graphene solid state battery also charges faster than other available batteries.

To make the battery of the subject technology, one would first need set up the solid Graphene case 10 that holds all of the parts in place. The process may include enhancing the energy density of the solid negatively charged Graphene Oxide Nickel-Copper anode 14 with a 100 femtosecond laser induced confined microexplosion. Then, the process may enhance the energy density of the solid positively charged Graphene Nickel-Copper nanocomposite electrode with a 100 femtosecond laser induced confined microexplosion. The anode 14 and cathode 12 may be positioned at opposite ends of the solid Graphene case 10. A Fluorinated Graphene (GF_{0.8}) electrolyte 16 may be deposited at the center of the case with the solid neutralized Graphene quantum dot separator 18 at the battery’s core in the middle of the battery.

In operation, the battery may be used to store energy for long periods of time without usage. The battery may also be used as a power source to generate valuable gas such as Hydrogen and Oxygen for internal combustion engines and fuel cells. The battery of the subject technology may also be configured to power airplanes and spacecraft. It is one of the most powerful, affordable, efficient and valuable battery technologies in the world.

Persons of ordinary skill idn the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

The present invention applies to a solid state graphene battery. The present battery may be recyclable, rechargeable, renewable and sustainable. The battery may comprise a solid state Graphene structure. As will be [symbol] the battery is unique and the first of its kind in the world, with an energy density of 2 kilowatt hours per kilogram or more. The energy density of Graphene-Oxide Nickel-Copper anode is estimated to be over 500 kilowatt hours per kilogram and the energy density of 100 femtosecond laser induced confined microexplosion energy density enhanced Fluorinated Graphene (GF_{0.8}) electrolyte of an estimated 2 kilowatt hours per kilogram. The optimal baseline energy density of the battery

What is claimed is:

1. A solid state battery, comprising:
a. a solid layered Graphene casing;
b. a solid negatively charged Graphene Oxide Nickel-Copper anode;
c. a solid positively charged Graphene Nickel-Copper cathode;
d. a solid Fluorinated Graphene (GF_{0.8}) electrolyte, and
e. a solid Carboxyl neutralized Graphene quantum dot separator.

2. The solid state battery according to claim 1, wherein the solid layered Graphene casing comprising is a 100 layered Graphene casing.

3. The solid state battery according to claim 1, wherein the solid positively charged Graphene Nickel-Copper cathode is positioned on one end of the casing.

4. The solid state battery according to claim 3, wherein the solid positively charged Graphene Nickel-Copper cathode is energy density enhanced by a 100 femtosecond laser induced confined microexplosion.

5. The solid state battery according to claim 1, wherein the solid negatively charged Graphene Oxide Nickel-Copper anode is positioned on an opposite end of the casing.

6. The solid state battery according to claim 5, wherein the solid negatively charged Graphene Oxide Nickel-Copper anode is energy density enhanced by a 100 femtosecond laser induced confined microexplosion.

7. The solid state battery according to claim 1, wherein the solid Fluorinated Graphene (GF_{0.8}) is positioned between the cathode and anode inside of the casing.

8. The solid state battery according to claim 1, wherein the solid Fluorinated Graphene (GF_{0.8}) electrolyte is energy density enhanced by a 100 femtosecond laser induced confined microexplosion.

9. The solid state battery according to claim 1, wherein the Carboxyl neutralized Graphene quantum dot separator is positioned at the center of the solid Fluorinated Graphene (GF_{0.8}) electrolyte inside of the casing.

10. The solid state battery according to claim 1, wherein the solid Carboxyl neutralized Graphene quantum dot separator is energy density enhanced by a 100 femtosecond laser induced confined microexplosion.

11. The solid state battery according to claim 9, wherein the solid 100 femtosecond laser induced confined microexplosion energy density enhanced Fluorinated Graphene (GF_{0.8}) electrolyte and Carboxyl neutralized Graphene quantum dot separator is positioned between the anode and the cathode.

12. The solid state battery according to claim 11, wherein the solid positively charged Graphene Nickel-Copper cathode that is energy density enhanced by a 100 femtosecond laser induced confined microexplosion and placed at one end of the 100 layered Graphene casing and the solid negatively charged Graphene Oxide Nickel-Copper anode that is energy density enhanced by a 100 femtosecond laser induced confined microexplosion is placed on the opposite side of the 100 layered graphene casing.
